(19) United States
(12) Patent Application Publication
(10) Pub. No.: US 2023/0075337 A1
(43) Pub. Date: Mar. 9, 2023

(54) COMPUTERISED METHOD AND SYSTEM FOR FOOD ORDER PLACEMENT AND AUTOMATED FULFILMENT

(71) Applicant: Abdul Wahab Khan, Santa Clata, CA (US)

(72) Inventor: Abdul Wahab Khan, Santa Clata, CA (US)

(21) Appl. No.: 17/467,178

(22) Filed: Sep. 4, 2021

(51) Int. Cl. G06Q 20/32; G06Q 50/12; H04W 4/02; H04W 12/50

(52) U.S. Cl. CPC G06Q 20/3274; G06Q 20/3224; G06Q 50/12; H04W 4/023; H04W 12/50

(57) ABSTRACT

A computer implemented and automated method for ordering food on a comprised based system and methods of fulfilling the order are described. The method includes determining the nearest location of a location of a restaurant and placing the order and performing all food order fulfillment steps, such as collecting payments, are described. The method also includes determining an automobile's route map and suggesting various location of the restaurant based on the automobile route maps. The system also determines congestions in traffic, backlogs at the restaurants, and other factors in making the suggesting restaurant locations for pickup. The method provides pick-up times and location details to a user's electronic device. In another embodiment, order is obtained from a cloud server. The user's mobile is paired with the restaurant and the QR code is obtained to process the order once the user arrives at the restaurant.

### FIELD OF THE INVENTION

The present invention generally relates to a computerized and automated system for food order placement, order fulfilment, and order management. More specifically, the present invention relates to a system that leverages mobile phone location, vehicle routing and navigation system data, store or restaurant order queue and backlog data, and restaurant locations to seamlessly fulfil an online order and execute instructions for pickup and payment.

### DISCUSSION OF THE RELATED ART

When picking up food to go, order placement at a restaurant can be cumbersome and time consuming. You have to stand in long lines and wait. When ordering online, you have to determine the location of the restaurant, details about the restaurant, for example if it is open at the current time, whether they accept whether they accept your payment options. Even after these selections, when you arrive at the restaurant, there may be delays in order processing and the customer may end up waiting much longer than anticipated. Although some systems exist that provide you a text message when your order is ready, the current methods don't utile eyes customer cell phone and vehicle navigation data or perform supply chain management operations to enhance the user experience and provide in order in time to the customer. Yet another problem with the current ordering systems is there is no transparency in order fulfilment and the customer is left in the dark guessing and waiting for their order, especially when the ultimately receive something they did not order or the item ordered is not available. As such a system and method is needed that leverage customer data and restaurant data to provide a better order placement an order management system.

### SUMMARY OF THE INVENTION

A computer implemented and automated system for food order placement, order fulfilment, and order management is described. More specifically, the present invention relates to a system that leverages mobile phone location, vehicle routing and navigation system data, store or restaurant order queue and backlog data, and restaurant locations to seamlessly fulfil an online order and execute instructions for pickup and payment.

The system includes a plurality of electronic devices communicatively connected to each other and centrally to a server. The server computer includes a plurality of components that are interconnected to each other either through digital circuitry or wireless means. The components include one or more processors, a bus for communications, server memory for storage of data, a database, an I/O device and a network interface.

In one embodiment, the system access is the customers electronic device to perform order fulfillment operations. For example, the server determines the location of the customer's mobile device and accordingly suggests a restaurant that is closest to the customer's current location. The system then performs order fulfillment operations and provides on the customer's mobile device, a QR code for order pick up. The system also provides pickup location, specific instructions regarding pickup, such as where to park in the parking lot of the restaurant, and payment instructions. In some embodiments the system may automatically access a stored credit card on the customer's mobile device and perform automatic payment collection for the order. When the customer arrives at the restaurant, the QR code may be accessed by a QR code reader and the order may be fulfilled.

In another embodiment the server determines that the customer is driving or about to start traveling on a specific route to a designated location. The server accesses routing information from the vehicle's navigation system and determines a restaurant location that is along the path of the vehicle to its designated destination. When there's a choice between one or more restaurants that lie along the path, the system provides options for the customer to select between the multiple locations.

In yet another embodiment, the system may determine restaurant backlog based on the current order. The system may access the current queue of multiple restaurants that are closest to the user's mobile location, or is along the path of the vehicle's routing to its destination. Based on the restaurant queue determination, the system had determined that one restaurant has a longer wait time than the other restaurant. As such the system may recommend or automatically provide details relating to a restaurant that has a lesser wait time.

### BRIEF DESCRIPTION OF THE DRAWINGS

The accompanying drawings are included to provide further understanding of the invention and constitute a part of the specification. The drawings listed below illustrate embodiments of the invention and, together with the description, serve to explain the principles of the invention, as disclosed by the claims and their equivalents.

FIG. 1A illustrates a process of receiving and processing a food order according to the disclosed embodiments;

FIG. 1B illustrates a process of determining restaurant backlog and switching the order to different restaurant based on backlog according to the disclosed embodiments;

FIG. 1C is an exemplary figure showing a plurality of restaurants in a geographical region and a routing map of an automobile according to the disclosed embodiments;

FIG. 2 illustrates a process of determining a restaurant based on a vehicle's routing map according to the disclosed embodiments; and

FIG. 3 depicts one embodiment of a system that is used in conjunction with the order placement and order fulfilment according to the disclosed embodiments;

FIG. 4 is an example of an electronic device used for performing the order placement according to the disclosed embodiments;

FIG. 5 is a block diagram of ordering fulfillment places, according to the disclosed embodiments;

FIG. 6 is an example of a global order fulfillment process using the cloud according to the disclosed embodiments;

FIGS. 7-10 are variations of the global order fulfillment process according to the disclosed embodiments.

### DETAILED DESCRIPTION

Although the specification concludes with claims which particularly point out and distinctly claim the invention, it is believed the present invention will be better understood from the following description.

The present invention can comprise, consist of, or consist essentially of the elements that are described in the specification. However, the invention is not so limited and any of the additional or optional ingredients, components, or limitations described herein are contemplated within.

As such, various aspects of the invention are disclosed in the accompanying description and alternative embodiments of the present invention and their equivalents are devised without parting from the spirit or scope of the present invention.

For example, in this application, the term restaurant or food vendor, when used is to be construed as a specific restaurant or restaurant type, it includes all food offering places such as fast-food restaurants, sit down restaurants, grocery stores that provide cooked food, or any store, stall, or vendor that provides cooked food or beverages.

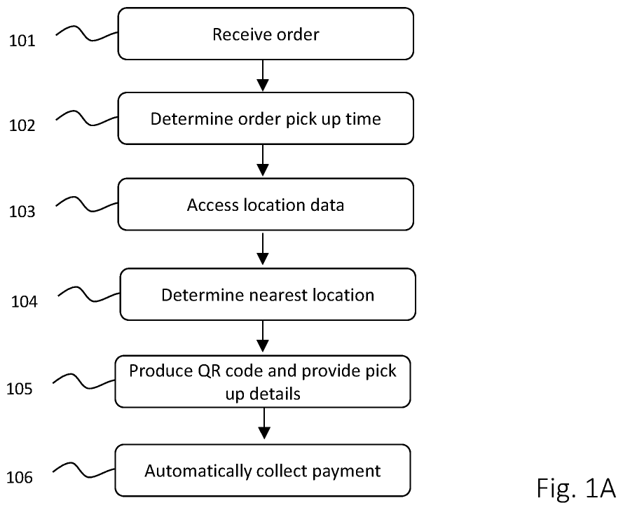

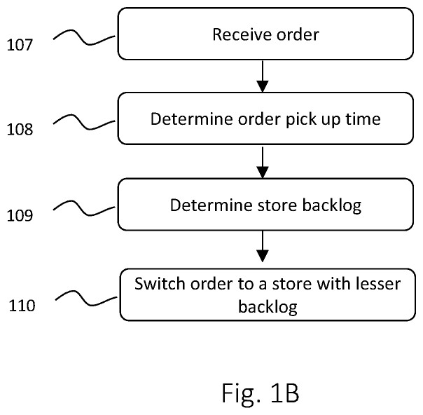

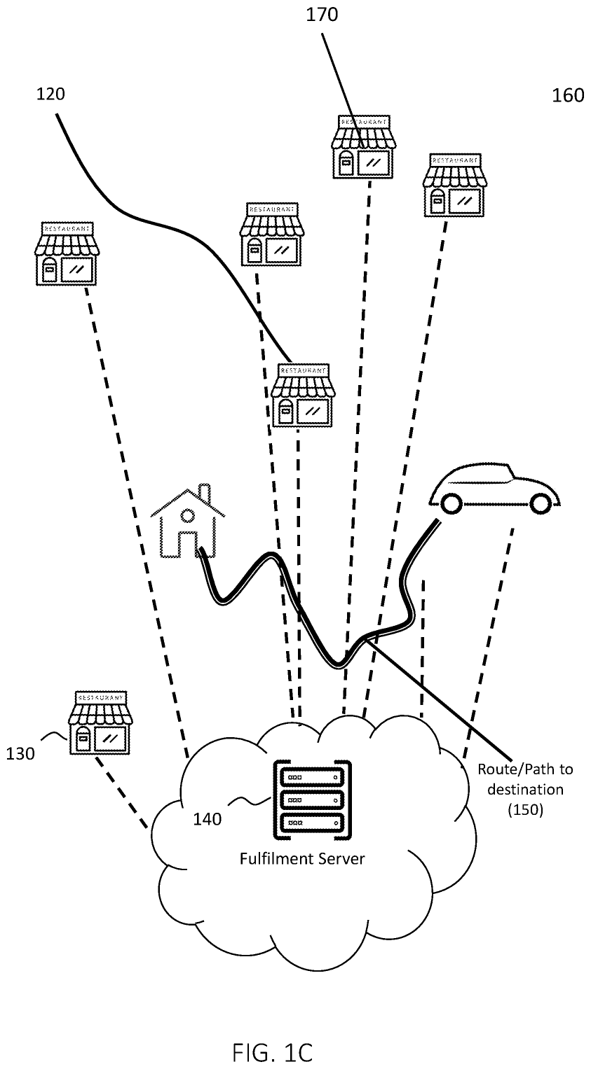

FIG. 1A depicts one embodiment of a system that is used in conjunction with the order placement, fulfilment, and management according to the disclosed embodiments. Embodiments of the system 300 provide an inventive apparatus(es), computer-based data processing algorithms and methods for conducting order placement, fulfilment, and management.

At block 101, an order is received. The order may be placed by a user that is desiring to place a restaurant order. The user may use an interface on their electronic device to place the order. For example, the user may use an application and select a plurality of options offered through the application to make an order. In one embodiment the mobile application may allow the user to select a plurality of touchscreen options for selecting the type of food and quantity of food and any embellishments to their food, such as extra sauce or holding a particular item or ingredient, such as holding back tomato or onion. The order may include food and drinks and any food related items that are offered by a restaurant or other food serving place. The system may also allow the user to make payment for the order and provide any additional instructions for fulfilling the order.

At block 102 the system determines the order pick up time. In one embodiment the user may provide a specific time, or a window of time, when the user intends to pick up the order. In another embodiment the system may automatically determine the order pick up time based on a plurality of parameters. For example, if a user places in order, and indicates that they are on their way to pick up the order, then the system may access the GPS of their mobile device and determine the amount of time it would take for the user to arrive at the restaurant location and accordingly at just the pickup time for the order.

In another embodiment, as depicted in block 103, the system may access in navigation system of an automobile that is used by the user for driving and picking up the order. The system may determine the amount of time based on their current road map that it would take to arrive at the restaurant location. The system may consider factors such as traffic and other variables to determine an approximate pick up time for the order. The system may accordingly adjust the order fulfillment process such that the food he's ready within a threshold. Of the arrival time of the automobile. That threshold period may vary and in some instances be within 5 to 10 minutes of the arrival time such that the food is hot, fresh, and ready when the user arrives at the pickup location.

In one embodiment, the restaurant or food vendor may have multiple locations that are dispersed across the city. For example, fast food restaurants such as McDonald's™ Burger King™, or other types of restaurants, such as Applebees™, and Olive Garden™ May have several locations in a busy city. In such an environment, at block 104, the system would determine the nearest location to the user for fulfilling the food order. For example, if two locations of the same restaurant exists in close proximity to the users current location, such as location a is 3 miles away, and location be is 4 miles away, then the system would pick location a which is closer to the user. in order to determine the closest location, the system may access the users GPS location of their mobile device or the GPS location of their automobile to determine which location of the restaurant is closest to the users current location.

In another embodiment the system may access the automobiles navigation routing map to determine which location of the restaurant falls along the path of the user's ultimate destination. For example if the user is driving to their work or a relative's house and the route map shows that location B, which is currently 3 miles away, falls along the path of the users ultimate direction, and location a, which is currently closer at 2 miles away falls in the opposite direction of the current routing map, then the system would pick location B even though it is farther from the current location because it would fall along the path and direction of the users ultimate destination as provider through their navigation routing map.

Add block 105 the system may generate a QR code and store it in the electronic device that is used by the user for making the order. The QR code may also pop up at that time of arrival at the restaurant location. When the user arrives at the restaurant location, the system may allow the scanning of the QR code by a restaurant employee to fulfill the order. In one embodiment, the restaurant may have scanners in the parking lot or other locations where the user may scan their own QR code to notify the restaurant of their arrival. In another embodiment the system may provide an application which detects that the user has entered the parking lot of the restaurant an automatically send the QR code as a message such that it can be used as a check-in to notify the restaurant that the user has arrived.

At block 106, the system may automatically collect payment from the user. In some embodiments, the user may save their credit card or other payment information in their mobile device, and the system through an application provided for ordering may automatically collect the payment and allow the user to add any tip as desired.

FIG. 1B illustrates a process of determining restaurant backlog and switching the order to different restaurant based on backlog according to the disclosed embodiments.

At block 107 a food order is received by the system. As described in FIG. 1A, the food order may be placed by user through a variety of means. For example, the user may use an application on their mobile device and using the touch screen options presented play set food order to a desired restaurant.

At block 108 the system may determine the order pick up time. In one embodiment, at block 109 the system may evaluate the restaurant backlog in determining the order pick up time. In this embodiment, that restaurant may look at the current queue of orders in the pipeline at the restaurant and determine add which time in the queue would the particular users order be ready. As such, depending on the backlog, the system may notified the user of a pick-up time, or a window I'll pick up time.

At block 110, a restaurant or a food vendor may have multiple locations. In the embodiment where the system determines that a particular location of the restaurant is backlogged and the fulfillment of the order will take a much longer time, then the system may automatically search for other restaurant locations that are within a threshold distance of the user to determine if fulfillment of the order in the other location would be faster than waiting to fulfill the order in the currently backlogged location. If a determination is made that another location can fulfill the order in a faster time, then the system would automatically transfer the order to the different location, and notify the user of the address and time of pickup at the different location.

FIG. 1C is an exemplary figure showing a plurality of restaurants in a geographical region and a routing map of an automobile according to the disclosed embodiments.

In one embodiment FIG. 1C shows a route/path 150 of an automobile to its final destination as depicted by a home icon. In this embodiment, the system may fulfill the order add restaurant location 120 since it is along the path of the automobile to its destination. The system may also determine if location 120 or location 130 might be faster to get to based on current traffic conditions. If a determination is made that detouring to location 120 may require additional time since location 120 is either not directly accessible by highway or because the route to location 120 is congested with traffic, then the system would evaluate if going to location 130 would be faster. The system would also evaluate if location 120 is backlog and if so, then switch the order to location 130. If the food fulfillment times are approximately the same at both locations, then the system would choose to fulfill the order add a location which falls fairly close to the path of the final destination, in this case it would be restaurant location 120.

The operations performed in process of FIG. 1C may be performed by a fulfillment server 140 that is connected to the all the locations of a restaurant. The server may communicate bi-directionally with each restaurant and also with the user devices to process and fulfill orders. The server may also cause a user interface to be displayed on a user device that can be used to select options to place a food order.

The server may also provide up-to date real time information to the user by transmitting information to the user device on a periodic basis such that the process is transparent and the user can visually see the progress of their order. For example, the server ma be connected to restaurant systems to inform the user that their order is now being cooked, or that it is now being packaged, or that it is next in queue to go on the grill/oven etc, thereby keeping the user informed of the food progress and any delays that may be caused. The system amy also interactive communication with the user device at the point in time needed. For example, once the order is in front of the chef and they are about to make it, and the chef notices that they are out of an ingredient, such as pickles, then the chef may suggest an alternative to the user and the user may receive an alert and respond such that the substitution is acceptable thereby allowing the Chef to prepare a food order that is desirable. The user may also indicate any allergies with respect to any substitutions or the user may store in a profile their allergies to food and the restaurant may access them while fulfilling the order.

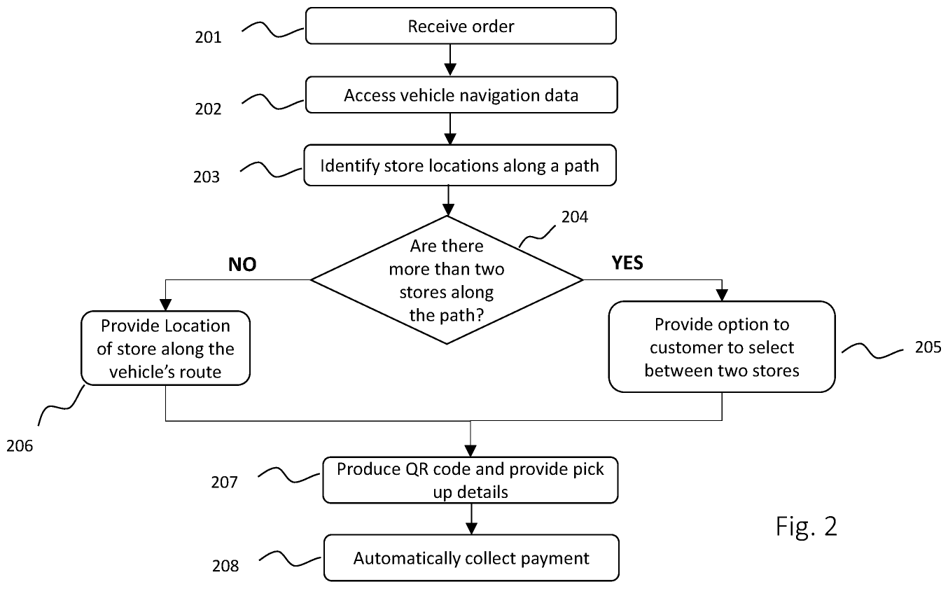

FIG. 2 illustrates a process of determining a restaurant based on a vehicle's routing map according to the disclosed embodiments.

At block 201 a food order is received. The food order may be received through a variety of means as described above. At block 202, the system accesses the vehicles navigation data and routing maps. At block 203, the system identifies store locations that are along the path of the vehicle to its final destination.

At block 204, a determination is made whether there are more than one location of the same restaurant that are along the path of the automobile to its final destination.

If that determination is made at block 204, that there are multiple locations along the path of the automobile to its final destination, then the system would provide options to the customer to select between the two stores at block 205. The system may also provide information such as current backlog, time required to drive to both locations, and any additional information and logistics that may correlate to the food fulfillment order, such as, if one location does not have a particular food item in stock, or does not have sufficient parking currently available.

If a determination is made at block three or four that only one restaurant falls along the path of the automobile to his final destination, then at block 206, the system would provide the location of the store that falls along the vehicles route.

At block 207, once the location is determined, a QR code is generated and provided to the user. As mentioned earlier the QR code may be saved in a particular location in a mobile application, or the system may provide a link or a pop-up closer to the time when the automobile arrives add the pick-up location such that the user may easily access the QR code. At block 208 the system may automatically collect payment for the food order.

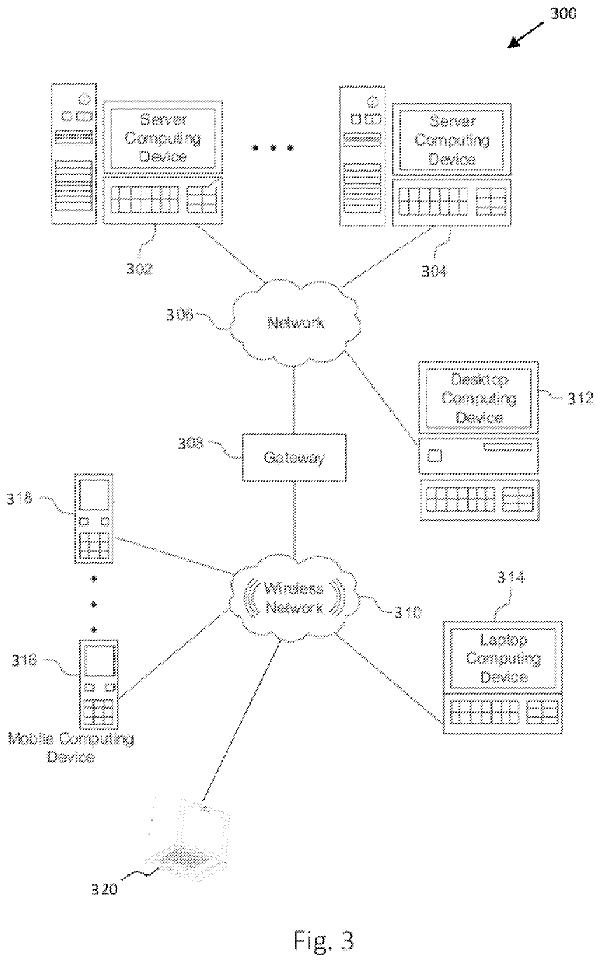

FIG. 3 depicts one embodiment of a system that is used in conjunction with the order placement and order fulfilment according to the disclosed embodiments.

System 300 is used in connection with the food ordering system and processes described in FIGS. 1A, 1B, 1C and 2. The system 300 includes one or more networks 304 and 306, such as a local area networks (LAN) and a wide area network (WAN) shown as network 306. The networks also store information related to food orders and payments and QR codes. The system 300 also includes wireless network 304 that allows devices in the network to wirelessly communicate with each other after pairing and/or other authorization between the devices.

Gateway 305 is configured to connect remote or different types of networks together, as well as client computing device 303 and server computing device 307, such as server fulfillment server 140 in FIG. 1C.

Client computing device 303 may include any device capable of receiving and sending data over a network, such as wireless network 304. Device 302 may include portable devices such as cellular telephones, smart phones, radio frequency-enabled devices, personal digital assistants, handheld computers, tablets, laptop computers, wearable computers and the like. The network is communicatively connected to the food ordering system through the gateway and the wireless network 304. The device 302, a mobile computing device, can transmit food orders to server, such as server fulfillment server 140 in FIG. 1C, and then to restaurant's computers, which are used in part to fulfill the food orders.

Client computing device 303 may be web-enabled client devices that include a browser application configured to receive and to send web pages, web-based messages and the like. The browser application may be configured to receive and display graphic, text, multimedia, or the like, employing virtually any web-based language, including a wireless application protocol messages (WAP), or the like.

Client computing device 303 also may include at least one other client application that is configured to receive content from another computing device, including, without limit, server computing device 307 (such as server fulfillment server 140 in FIG. 1C). The client application may include a capability to provide and receive textual content, multimedia information, or the like. The client application may further provide information that identifies itself, including a type, capability, name, or the like. The server computing device 307 may also be part of the restaurant where it can be used to access food orders submitted by a user/consumer.

Client computing device 303 may also be configured to communicate a message, such as through email, short message service (SMS), multimedia message service (MMS), instant messaging (IM), which may include both video and audio messages to another computing device.

The client device, such as the user's mobile phone or laptop, such as device 316, 318 or 320, may communicate with devices in the network or the server using a wireless transmitter, such as a standard off-the shelf transmitter. Alternatively, the user device, such as device 316, 318 or 320, may communicate to other mobile devices over the air without Bluetooth. Other methods of sending and receiving signals and messages to internet capable devices are also contemplated. For example, the wireless transmitter along with an antenna may be used to send an alert to a user's mobile phone or a designated phone alerting that the food order is ready for pickup.

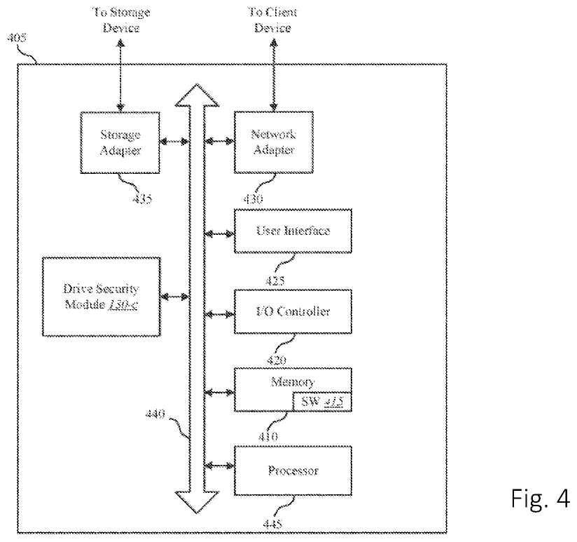

FIG. 4 is an example of an electronic device used for performing the order placement according to the disclosed embodiments. Device 400 may include an apparatus 405, which may be an example of any one of devices, such as device 316, 318 or 320 of FIG. 3.

Apparatus 405 may include components for bi-directional voice and data communications including components for transmitting communications and components for receiving communications. For example, apparatus 405 may communicate bi-directionally with one or more storage devices and/or client systems, server, or systems located at the restaurants. This bi-directional communication may be direct (apparatus 405 communicating directly with a storage system, for example) and/or indirect (apparatus 405 communicating indirectly with a client device through a server, for example).

Apparatus 405 may also include a processor module 445, and memory 410 (including software/firmware code (SW) 415), an input/output controller module 420, a user interface module 425, a network adapter 430, and a storage adapter 435. The software/firmware code 415 may be one example of a software application executing on apparatus 405. The network adapter 430 may communicate bi-directionally, via one or more wired links and/or wireless links, with one or more networks and/or client devices. In some embodiments, network adapter 430 may provide a direct connection to a client device via a direct network link to the Internet via a POP (point of presence). In some embodiments, network adapter 430 of apparatus 405 may provide a connection using wireless techniques, including digital cellular telephone connection, Cellular Digital Packet Data (CDPD) connection, digital satellite data connection, and/or another connection. The apparatus 405 may include drive security module 130-c, which may perform the functions described above for the drive security module 130 of FIGS. 1A, 1B, 1C and/or 2.

The signals associated with system 400 may include wireless communication signals such as radio frequency, electromagnetics, local area network (LAN), wide area network (WAN), virtual private network (VPN), wireless network (using 802.11, for example), cellular network (using 3G and/or LTE, for example), and/or other signals. The network adapter 430 may enable one or more of WWAN (GSM, CDMA, and WCDMA), WLAN (including BLUETOOTH.RTM. and Wi-Fi), WMAN (WiMAX) for mobile communications, antennas for Wireless Personal Area Network (WPAN) applications (including RFID and UWB), or any combination thereof.

One or more buses 440 may allow data communication between one or more elements of apparatus 405 such as processor module 445, memory 410, I/O controller module 420, user interface module 425, network adapter 430, and storage adapter 435, or any combination thereof.

The memory 410 may include random access memory (RAM), read only memory (ROM), flash memory, and/or other types. The memory 410 may store computer-readable, computer-executable software/firmware code 415 including instructions that, when executed, cause the processor module 445 to perform various functions described in this disclosure, such as ordering food or collecting food payments. Alternatively, the software/firmware code 415 may not be directly executable by the processor module 445 but may cause a computer (when compiled and executed, for example) to perform functions described herein. Alternatively, the computer-readable, computer-executable software/firmware code 415 may not be directly executable by the processor module 445, but may be configured to cause a computer, when compiled and executed, to perform functions described herein. The processor module 445 may include an intelligent hardware device, for example, a central processing unit (CPU), a microcontroller, an application-specific integrated circuit (ASIC), field programmable gate array (FPGA), or any combination thereof.

In some embodiments, the memory 410 may contain, among other things, the Basic Input-Output system (BIOS) which may control basic hardware and/or software operation such as the interaction with peripheral components or devices. For example, at least a portion of the drive security module 130-c to implement the present systems and methods may be stored within the system memory 410. Applications resident with system 400 are generally stored on and accessed via a non-transitory computer readable medium, such as a hard disk drive or other storage medium. Additionally, applications can be in the form of electronic signals modulated in accordance with the application and data communication technology when accessed via a network interface such as network adapter 430.

Many other devices and/or subsystems may be connected to and/or included as one or more elements of system 400 (for example, a personal computing device, mobile computing device, smart phone, server, internet-connected device, cell radio module, or any combination thereof). In some embodiments, all of the elements shown in FIG. 4 need not be present to practice the present systems and methods. The devices and subsystems can be interconnected in different ways from that shown in FIG. 4. In some embodiments, an aspect of some operation of a system, such as that shown in FIG. 4, may be readily known in the art and are not discussed in detail in this application. Code to implement the present disclosure can be stored in a non-transitory computer-readable medium such as one or more of system memory 410 or other memory. The operating system provided on I/O controller module 420 may be a mobile device operation system, a desktop/laptop operating system, or another known operating system.

The I/O controller module 420 may operate in conjunction with network adapter 430 and/or storage adapter 435. The network adapter 430 may enable apparatus 405 with the ability to communicate with client devices such as devices 316, 318 or 320 of FIG. 3, and/or other devices over a communication network. Network adapter 430 may provide wired and/or wireless network connections. In some cases, network adapter 430 may include an Ethernet adapter or Fibre Channel adapter. Storage adapter 435 may enable apparatus 405 to access one or more data storage devices such as storage media 110. The one or more data storage devices may include two or more data tiers each. The storage adapter 435 may include one or more of an Ethernet adapter, a Fibre Channel adapter, Fibre Channel Protocol (FCP) adapter, a SCSI adapter, and iSCSI protocol adapter. Thus, it is intended that the present invention covers the modifications and variations of the embodiments disclosed above provided that the modifications and variations come within the scope of any claims and their equivalents.

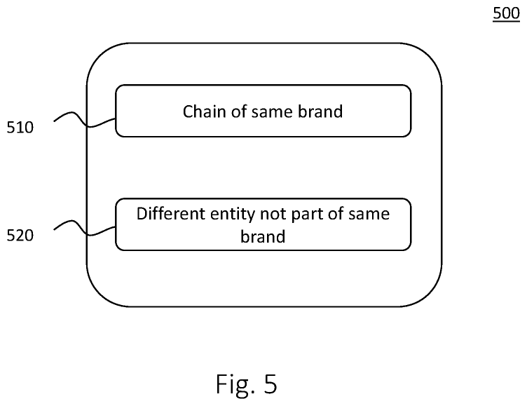

FIG. 5 is a block diagram of ordering fulfillment places, according to the disclosed embodiments. In accordance with FIG. 5, as depicted in block 510, an order discussed above can be fulfilled at location of the same restaurant, grocery store, or food offering places. For example, if the order is placed at a McDonalds™, then it will be fulfilled at any one or more locations of McDonalds™.

At block 520, the order may be fulfilled at any food offering place that is not part of the same brand. For example, if a burger is ordered, any restaurant, store, of food offering place and fulfill the order regardless of whether they are part of the same chain or not. In some instances, an alert may be send to the user so they can approve the fulfillment place and brand.

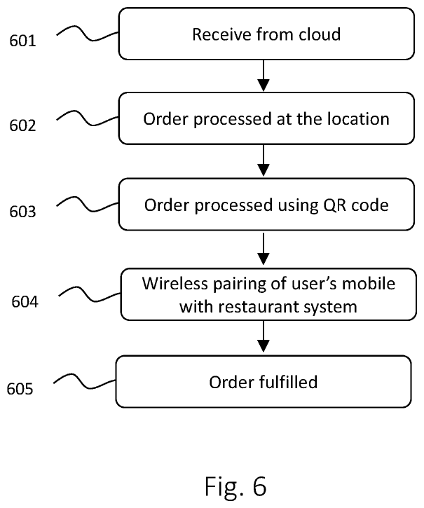

FIG. 6 is an example of a global order fulfillment process using the cloud according to the disclosed embodiments.

At step 601, an order is received at the restaurant or food offering place from the cloud.

At block 602, the order is processed at the location where it is going to be fulfilled. In one embodiment, the order is only processed once the user arrives at the location and in another embodiment, the order may be processed prior to the user arriving at the location.

At step 603, the order is processed at the food offering place based on the presentation of a QR code.

At block 604, the user's mobile is wirelessly paired with the restaurant's system such that information may be exchanged. In some embodiments, the QR code may be provided based on this established pairing.

At block 605, the restaurant fulfills the user's order.

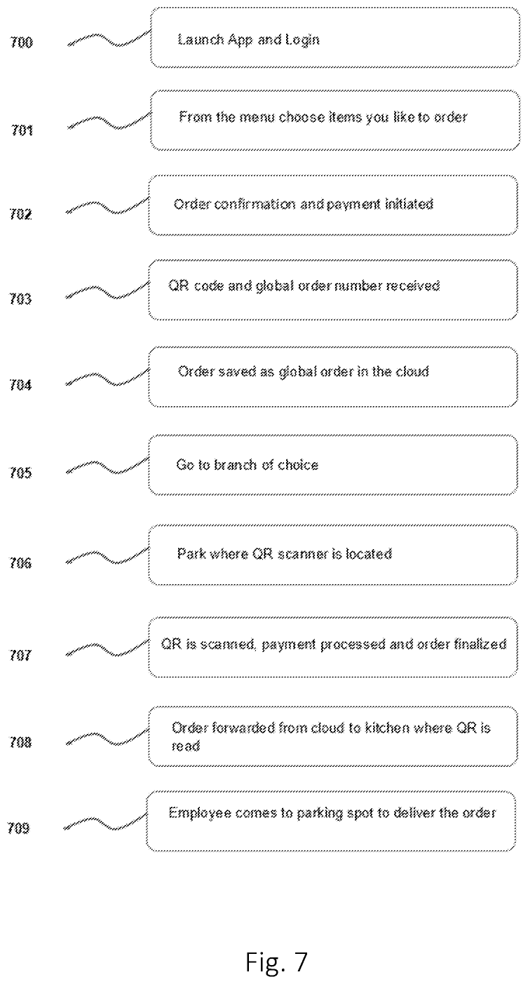

FIG. 6-10 are variations of the global order fulfillment process described in FIG. 6 according to the disclosed embodiments. These variations include using QR codes to fulfill the order placed by a user. In one such embodiment, as described in FIG. 7, at 700 a user launches an application on their mobile phone, registers an account and logs in using the application.

At 701 the user selects a one or more food items from a menu offered. The menu may be from a particular brand name food place, such as a restaurant.

At 702 the order is confirmed by the food place and payment is initiated. The payment may be stored on the application by the user, listed in their profile, or entered at this time into the application.

At 703 a QR code and a global order number is received.

At 704 the order is saved as a global order in the cloud.

At 705 the user drives or walks to the branch of their choice. For example, if the brand name food place has multiple locations, the user may go to any of their locations based on their choice. Alternatively, the user may go to a specific location that they selected in the application.

At 706 the user parks their car at a location in the food place, such as a parking lot or a designated location, where a QR scanner is located.

At 707, the QR code is scanned, the payment is processed, and the order is finalized.

At 708, the order is forwarded from the cloud to the kitchen where the QR code is read. This may be from a cloud server to the restaurant.

At 709, an employee of the food place may deliver the food order to the user at their parked location.

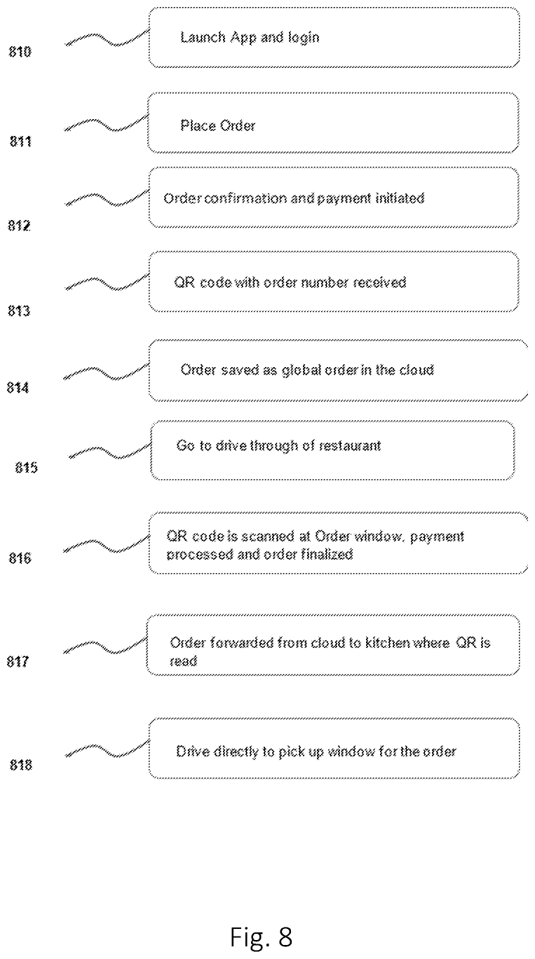

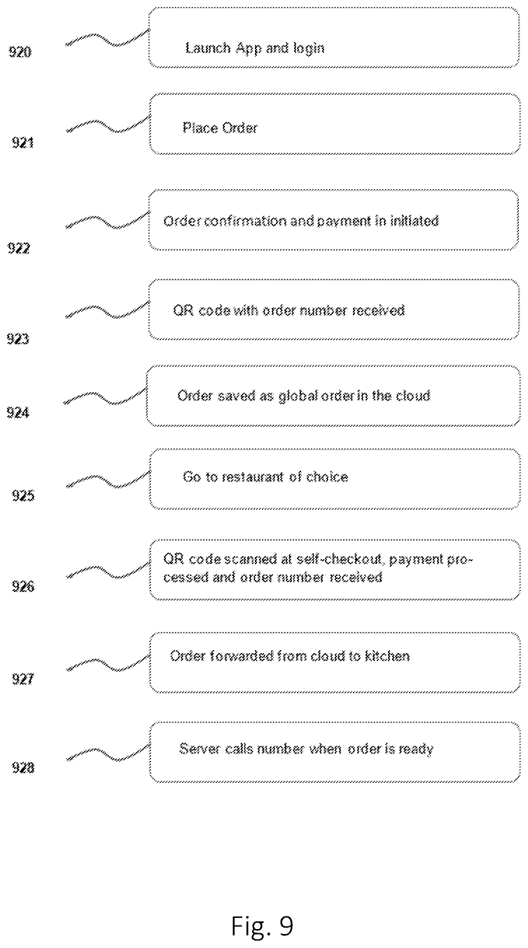

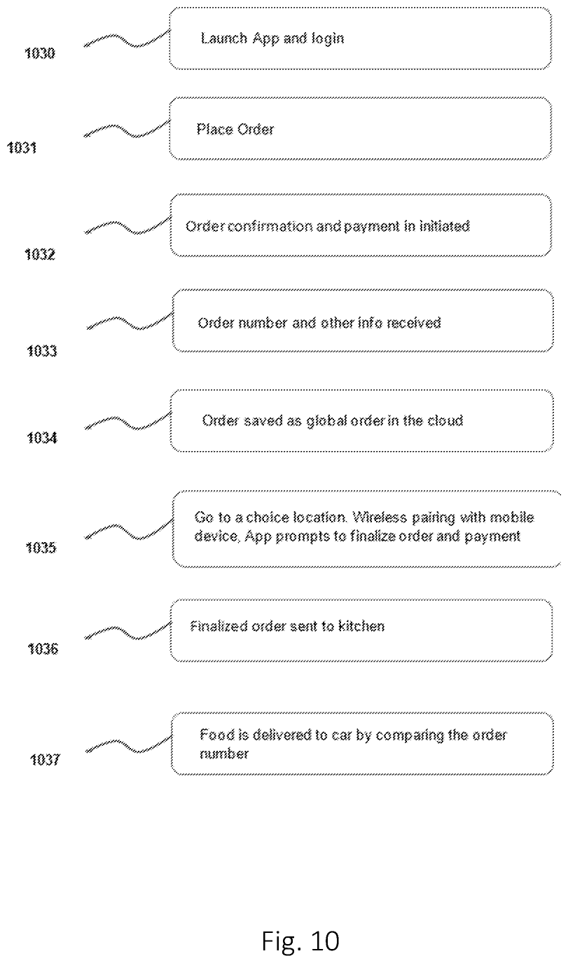

Although the description of the global ordering system has been described in reference to FIG. 7 above, the embodiments are not so limited and other variations of this process, such as those described in steps 810-818 in FIG. 8, 920-928 in FIG. 9, or 1030-1037 in FIG. 10 may also be used.

What is claimed is:

1. A computer implemented and automated method for order placement and fulfillment comprising:
receiving a consumable food or drink order on an online platform from an electronic device, wherein the order is directed to a store brand that is capable of fulfilling the consumable food or drink order;
obtaining the attributes of the received order;
determining a location of the electronic device associated with the received order;
calculating a distance between the location of the electronic device and one or more stores associated with the store brand; and
processing the received order by sending it to the store, from among the one or more stores associated with the store brand, which is closest in distance to the electronic device; and
fulfilling the order at the store that is closest in distance to the electronic device.

2. The method of claim 1, wherein the store is selected from a group consisting of restaurant, chain of restaurants, ice cream shop, coffee shops, fast food chain, grocery store, meat store, beverage store, and convenience store.

3. The method of claim 1, wherein fulfilling the order further comprises displaying a QR code on the electronic device.

4. The method of claim 1, wherein fulfilling the order further comprises:
reading QR code using a QR reader;
confirming the order related to the QR code; and
alerting a user associated with the electronic device when the order is ready for pick up.

5. The method of claim 2, wherein fulfilling the order further electronically acceding the QR code and automatically processing the order when the electronic device is within a proximate distance of the store.

6. The method of claim 2, wherein the proximate distance is within two miles if the electronic device is located in a moving vehicle.

7. The method of claim 2, wherein the proximate distance is within half a mile if a user associated with the electronic device walking towards the store.

8. The method of claim 2, wherein the proximate distance is a predetermined distance that can be set by a user or the system.

9. The method of claim 2, wherein the proximate distance is determined based on whether the electronic device is located inside a moving vehicle or is held by a user that is walking with the electronic device.

10. A method for order fulfillment at a restaurant comprising:
receiving a food or drink order from a cloud server;
processing the order at a location designated in the received food or drink order;
wirelessly pairing a user's device that is associated with the order with the restaurant's system;
using the paired connection, obtaining a QR code from the user's device; and
fulfilling the order at the restaurant.

11. The method of claim 8, further comprising, sending an alert to the use when the order is fulfilled.

12. The method of claim 8, further comprising, saving the food or drink order to a cloud.

13. The method of claim 8, further comprising, processing the food or drink order only after a user placing the order has arrived at the location of the restaurant, and scanned a QR code using a scanner of the restaurant.

14. The method of claim 12, further comprising, forwarding the food or drink order from the cloud to the kitchen of the restaurant.

15. The method of claim 12, further comprising, processing the food or drink order after a user scans the QR using a scanner located in a parking lot or a designated location of the restaurant.
